(19) United States
(12) Patent Application Publication
(10) Pub. No.: US 2020/0125752 A1
(43) Pub. Date: Apr. 23, 2020

(54) METHOD AND SYSTEM FOR ANONYMOUS INFORMATION RIGHTS MANAGEMENT TO ALLOW TRACKING OF DOWNLOADED DOCUMENTS WITHOUT AUTHENTICATION

(71) Applicant: Intralinks, Inc., New York, NY (US)

(72) Inventors: Andreea Farcas, Gheraesti (RO); Constantin Miroslav, Bragadiru (RO); Arpad Piskolti, Bucharest (RO); Dan Gheorghe, New York, NY (US); Andrei Rinea, New York, NY (US); Harshal Morparia, Lexington, MA (US); Oana Mihai, New York, NY (US); Adrian Petre, New York, NY (US); Liviu Lupei, New York, NY (US); Bryan Mannetta, New York, NY (US); Prasad Prabhu, New York, NY (US)

(21) Appl. No.: 16/656,753

(22) Filed: Oct. 18, 2019

Related U.S. Application Data
(60) Provisional application No. 62/747,888, filed on Oct. 19, 2018.

(51) Int. Cl. G06F 21/62; H04L 9/08

(52) U.S. Cl. CPC G06F 21/6209; G06F 2221/2141; G06F 2221/2101; H04L 9/0816

(57) ABSTRACT

A computer implemented method and system for anonymous information rights management to allow tracking of downloaded documents without authentication is disclosed. The method comprises receiving, at an IRM server, a request from an anonymous user to access an encrypted document; in response to receiving the request from the anonymous user, determining an identity of a first user who downloaded the encrypted document from the IRM server, wherein the first user is different from the anonymous user; determining whether the first user currently has permission to access to the encrypted document; and providing a decryption key to the anonymous user when the first user is determined to have permission to access the encrypted document.

### BACKGROUND

### Field

Embodiments of the present invention generally relate to information rights management and more specifically, to a method for anonymous information rights management to allow tracking of downloaded documents without authentication.

### Description of the Related Art

Information rights management (IRM) protects sensitive information from unauthorized access. IRM solutions use encryption to prevent unauthorized access, using for example, a key to control access to the encrypted data. Once a document is encrypted against unauthorized users, an IRM user can apply certain access permissions that permit or deny a user from taking certain actions on a piece of information, such as allowing a user to read a document, but denying the user the ability to print the document.

When a user wishes to access an encrypted file, the user must log into to the IRM server to verify themselves. Once verified, a key is sent to the user, the key enabling access to the encrypted file. All access to the file is tracked. As such, a history is maintained for each file, including for example, who accessed the file, when the file was accessed, where the file was accessed, if the file was printed, and the like. If the user attempts to access an encrypted file after the user is no longer allowed access to the file, the key will not be sent to the user and the access is denied. However, requiring a user to verify themselves to the IRM each time a document is accessed is burdensome. In addition, if the user were to download the document and then share the document via email or other sharing mechanism with for example members of their team, there is no way to track the history of access by those users with whom the document was shared. In addition, there is no way to prevent access by those users if the user who downloaded the document is no longer allowed access.

Therefore, there is a need for a method for anonymous information rights management to allow tracking of downloaded documents without authentication.

### SUMMARY

An apparatus and/or method is provided for anonymous information rights management to allow tracking of downloaded documents without authentication substantially as shown in and/or described in connection with at least one of the figures.

Other and further embodiments of the present invention are described below.

### BRIEF DESCRIPTION OF THE DRAWINGS

FIG. 1 depicts a block diagram of a system for anonymous information rights management to allow tracking of downloaded documents without authentication, according to one or more embodiments of the invention;

FIG. 2 depicts a flow diagram of a method for anonymous information rights management to allow tracking of downloaded documents without authentication, according to one or more embodiments of the invention; and

FIG. 3 depicts a computer system that can be utilized in various embodiments of the present invention to implement the computer and/or the display, according to one or more embodiments of the invention.

While the method and apparatus is described herein by way of example for several embodiments and illustrative drawings, those skilled in the art will recognize that the method and apparatus for anonymous information rights management to allow tracking of downloaded documents without authentication is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for anonymous information rights management to allow tracking of downloaded documents without authentication defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Embodiments of the invention provide a system and method for anonymous information rights management to allow tracking of downloaded documents without authentication. A first user with login credentials downloads an encrypted document from a document database monitored by an IRM server. When the first user accesses the document, the user is asked to verify him or herself to the IRM server. When the user is successfully verified, a decryption key is transmitted to the device of the first user and a document access history for the document is updated to reflect the access by the first user. The first user may then share the encrypted document with, for example, a team of co-workers. The first user may share the encrypted document via email or by placing the encrypted document in a shared document database where it can be accessed by others. When a second user attempts to access the shared encrypted document, the second user need not verify him or herself to the IRM server. In fact, the second user may not be known to the IRM server. Instead, the access permissions of the first user, who originally downloaded the encrypted document are identified. If the first user is still allowed access to the document, the decryption key is sent to the device of the second user and the document is automatically opened without authentication of the second user. The document access history for the document is updated to reflect the document was access by someone associated with the first user, and may include an internet protocol (IP) address, or any available identifying information about the device of the second user.

Advantageously, the present invention allows the tracking and security to remain with the document even after the document has been downloaded and accessed by unverified and unknown or anonymous users.

Various embodiments of a method and apparatus for anonymous information rights management to allow tracking of downloaded documents without authentication are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

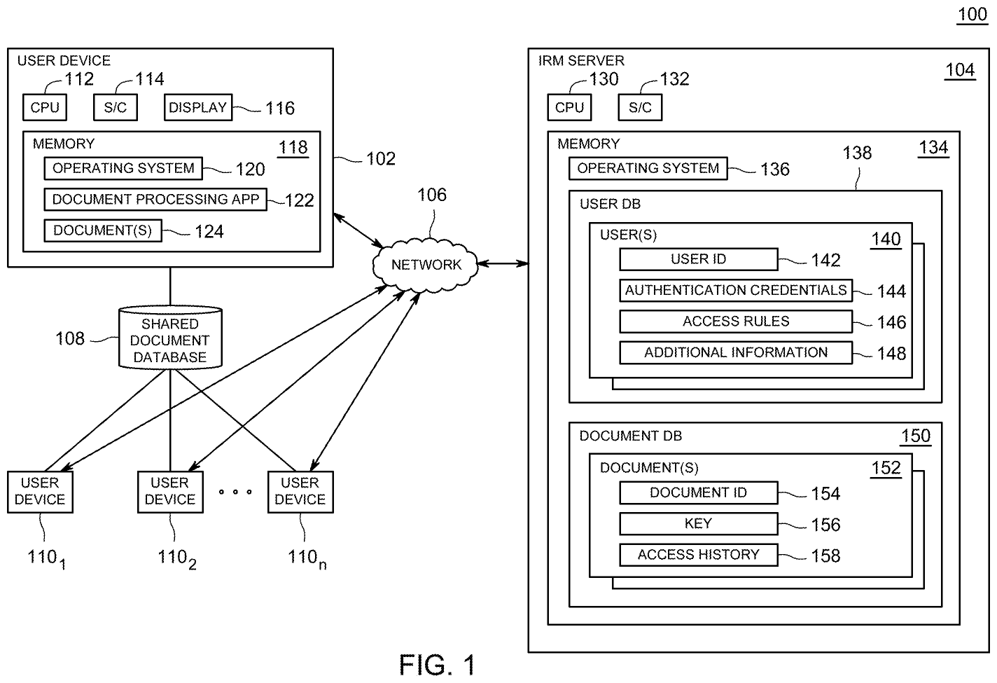

FIG. 1 depicts a block diagram of a system 100 for anonymous information rights management to allow tracking of downloaded documents without authentication, according to one or more embodiments of the invention. The system 100 includes a user device 102 of a user who is authorized to retrieve documents managed by the IRM server 104. The user device 102 and IRM server are communicatively coupled to one another via network 106. In some embodiments, the user device 102 is connected via a wired or wireless connection to a shared document database 108 or other document storage facility where documents may be shared with other user, such as those associated with user device 110₁, 110₂, . . . 110ₙ (collectively referred to as user device 110), wherein the users of user devices may not be known users to the IRM server 104.

The user device 102 is a computing device, for example, any one of a desktop computer, laptop, tablet computer, and the like. The user device 102 includes a Central Processing Unit (CPU) 112, support circuits 114, a display 116, and a memory 118. The CPU 112 may include one or more commercially available microprocessors or microcontrollers that facilitate data processing and storage. The various support circuits 114 facilitate the operation of the CPU 112 and include one or more clock circuits, power supplies, cache, input/output circuits, and the like. The memory 118 includes at least one of Read Only Memory (ROM), Random Access Memory (RAM), disk drive storage, optical storage, removable storage and/or the like.

The memory 118 includes an operating system 120, a document processing application 122, and one or more documents 124. The document processing application 122 may be any document processing application, such as MICROSOFT® Word, ADOBE® ACROBAT®, and the like. The operating system 120 may include various commercially known operating systems.

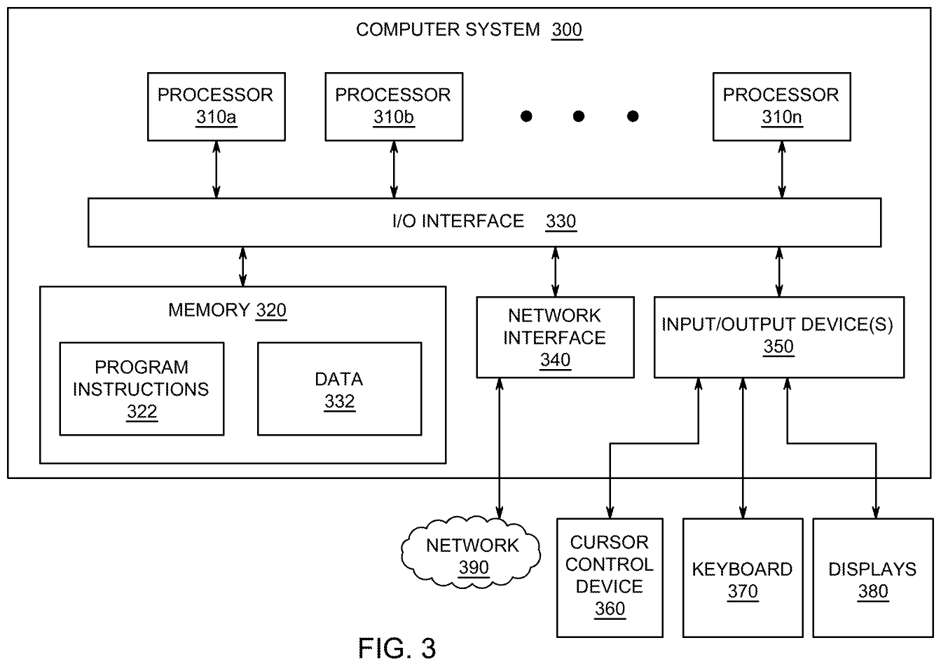

The IRM server 104 is a computing device, for example, a desktop computer, laptop, tablet computer, and the like, or it may be a clod based server (e.g., a blade server, virtual machine, and the like). One example of a suitable computer is shown in FIG. 3, which is described in detail below. The IRM server 104 includes a Central Processing Unit (CPU) 130, support circuits 132, and a memory 134. The CPU 130 may include one or more commercially available microprocessors or microcontrollers that facilitate data processing and storage. The various support circuits 132 facilitate the operation of the CPU 130 and include one or more clock circuits, power supplies, cache, input/output circuits, and the like. The memory 134 includes at least one of Read Only Memory (ROM), Random Access Memory (RAM), disk drive storage, optical storage, removable storage and/or the like.

The memory 134 includes an operating system 136, a user database 138 and a document database 150. Although the document database 150 is depicted as part of the IRM server 104, those skilled in the art will appreciate that the document database 150 may be remote from the IRM server 104. The operating system 136 may include various commercially known operating systems. The user database 138 stores information about a plurality of users 140 who may have access to the document database 150. For each user 140, there is stored a user ID 142, authentication credentials 144, access rules 146, and may include additional information 148 associated with the user 140. The document database 150 includes a plurality of documents 152. For each document, there is stored a document ID 154, a decryption key 156, and an access history 158, which is a log of each time the document was accessed and may also include additional information such as who accessed the document, a geolocation of where the document was accessed, a MAC address and/or IP address of the device that accessed the document, the type of access (e.g., open document, print document), and the like. The key 156 is needed to decrypt the document 152, as all documents 152 are encrypted. Although the decryption key 156 is depicted as being store with the document 152, those skilled in the art appreciate that the key may be store in an alternate location, such as a key store or other secure location.

The user devices 110 are computing devices similar to user device 102; however, user devices 110 may not retrieve the documents from the document database 150, but rather had the documents 124 shared with them, for example in a shared document database 108, in an email, and the like. The users of user devices 110 may not have authentication credentials 144 registered with the IRM server 104.

A user 140 of user device 102, for example, a manager of a team, may need his team to review a document. The user provides authentication credential (e.g., a login and password) to the IRM server 104 and if the provided credentials match the authentication credentials 144 stored at the IRM server 104, the user is verified. The user 140 may then send a request for a document 152 to the IRM server 104. The document 152 is downloaded and stored on user device 102 as document 124. The document access history 158 is updated to reflect that the user 140 downloaded the document 124. When the user 140 of user device 102 attempts to open the document 124, the user 140 must authenticate him or herself again to the IRM server 104. If the user 140 is authenticated the key 156 is sent to the user device 102, which decrypts the document 24. The user 140 is allowed access to the document based on the access rules 146. Access rules 146 may simply include read and print privileges or access rules 146 may include more advanced access privileges. A more advanced access rule 146 may provide that a document 152 may not be opened if the user device 102 is not located in a specific location, for example, within the United States. The access rules 146 may indicate a number of times a document 152 may be opened. The access rules 146 may indicate a time period in which a document 152 may be accessed by the user 140. Any restrictions on access may be included in access rules 146. The access by the user 140 is logged in the document access history 158.

The user 140 may then share the encrypted document 124 with others by for example, storing the document 124 in a shared document database 108 or by emailing or transmitting the document 124 by other means for access by other users, such as his or her team members.

When a user of user device 110 attempts to access the shared document, a request is sent to the IRM server 104 for the key 156 that will decrypt the shared document. The IRM server 104 determines which user 140 originally downloaded the document and checks the access rules 146 to determine whether the user 140, is still allowed access to the document. If so, the key 156 is sent to the user device 110 without the user of user device 110 being known or authenticated. The permissions granted in the access rules 146 are passed onto the user of user device 110 and the document access history 158 for the document is updated with the unknown user's access. Although the user is anonymous, the original user 140 of user device 102 is known, and the document access history 158 is updated to show the known user, the access by the anonymous user, and in some embodiments the date, time, location, MAC address, IP address of the user device 110, and/or the like.

As such, although the document 152 has been downloaded, security and tracking of the document 152 are maintained.

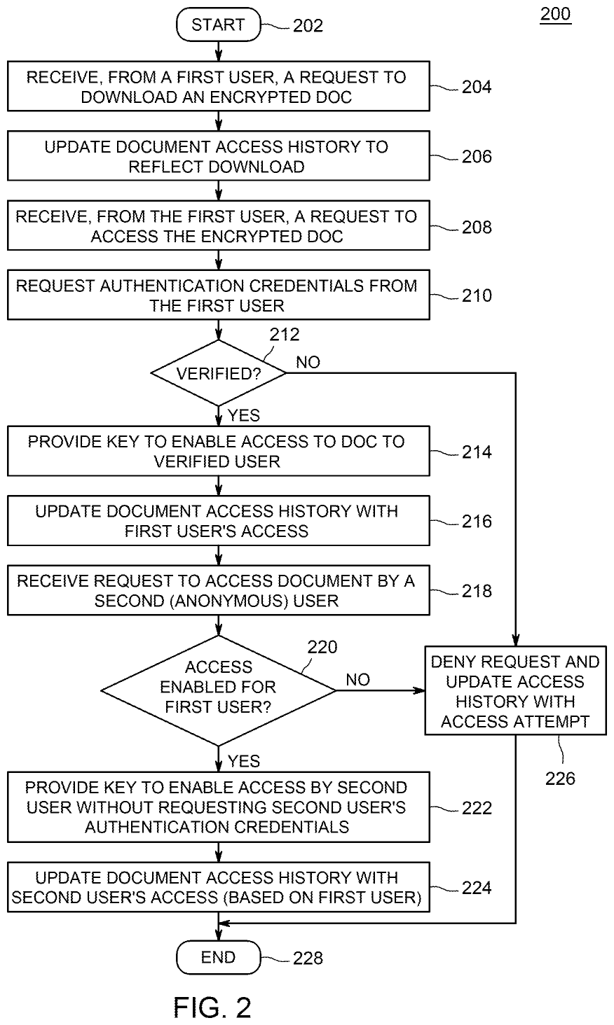

FIG. 2 depicts a flow diagram of a method 200 for anonymous information rights management to allow tracking of downloaded documents without authentication, according to one or more embodiments of the invention. The method 200 is performed on the IRM server 104. The method 200 starts at step 202 and proceeds to step 204.

At step 204, a request is received to download a document. The request is received from a first user on a user device. The first user is a verified user known to the IRM server. At step 206, a document access history of the document is updated to reflect that the first user has downloaded the document. At step 208, a request is received from the first user to access the downloaded document and at step 210, authentication credentials are requested from the first user.

At step 212, the authentication credentials received from the first user do not match the authentication credentials stored at the IRM server, then the method 200 proceeds to step 226, where a message is sent to the user denying the request, and the document access history is updated to reflect that a document access was attempted and denied, at which time the method 200 proceeds to step 228 and ends.

However, if at step 212, it is determined that the authentication credentials received from the first user match the authentication credentials stored at the IRM server, then the user is verified and the method 200 proceeds to step 214.

At step 214, a key is transmitted to the user device enabling access by the first user to the encrypted document. At step 216, the document access history is updated to reflect access by the first user.

At step 218, a request is received to access the document. The access request is from a second user, where the second user is different from the first user and the second user is anonymous. No information is known about the user; however, information is known about the document being accessed, specifically, the user who downloaded the document (i.e., the first user).

At step 220, it is determined whether the first user has access to the document. Since the document was downloaded by the first user, the first user may no longer be allowed to access the document. For example, the access rules associated with the user may dictate that the timeframe in which the first user may access the document is over. If access is no longer enabled for the first user, the method 200 proceeds to step 226, where a message is sent to the user denying the request, and the document access history is updated to reflect that a document access was attempted and denied, at which time the method 200 proceeds to step 228 and ends.

However, if at step 220, it is determined that the first user is still allowed access to the document, then the method 200 proceeds to step 222.

At step 222, the decryption key for accessing the document is provided to the second user without requesting the identity of the user or any authentication credentials.

At step 224, the document access history 158 is updated to reflect access by the anonymous user, where the update reflects the name of the first user who shared the document. At step 228, the method 200 ends.

FIG. 3 depicts a computer system 300 that can be utilized in various embodiments of the present invention to implement the computer and/or the display, according to one or more embodiments of the invention.

Various embodiments of method and apparatus for anonymous information rights management to allow tracking of downloaded documents without authentication, as described herein, may be executed on one or more computer systems, which may interact with various other devices. One such computer system is computer system 300 illustrated by FIG. 3, which may in various embodiments implement any of the elements or functionality illustrated in FIGS. 1-2. In various embodiments, computer system 300 may be configured to implement methods described above. The computer system 300 may be used to implement any other system, device, element, functionality or method of the above-described embodiments. In the illustrated embodiments, computer system 300 may be configured to implement the method 200 as processor-executable program instructions 322 (e.g., program instructions executable by processor(s) 310) in various embodiments.

In the illustrated embodiment, computer system 300 includes one or more processors 310a-310n coupled to a system memory 320 via an input/output (I/O) interface 330. Computer system 300 further includes a network interface 340 coupled to I/O interface 330, and one or more input/output devices 350, such as cursor control device 360, keyboard 370, and display(s) 380. In various embodiments, any of the components may be utilized by the system to receive user input described above. In various embodiments, a user interface may be generated and displayed on display 380. In some cases, it is contemplated that embodiments may be implemented using a single instance of computer system 300, while in other embodiments multiple such systems, or multiple nodes making up computer system 300, may be configured to host different portions or instances of various embodiments. For example, in one embodiment some elements may be implemented via one or more nodes of computer system 300 that are distinct from those nodes implementing other elements. In another example, multiple nodes may implement computer system 300 in a distributed manner.

In different embodiments, computer system 300 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 300 may be a uniprocessor system including one processor 310, or a multiprocessor system including several processors 310 (e.g., two, four, eight, or another suitable number). Processors 310 may be any suitable processor capable of executing instructions. For example, in various embodiments processors 310 may be general-purpose or embedded processors implementing any of a variety of instruction set architectures (ISAs). In multiprocessor systems, each of processors 310 may commonly, but not necessarily, implement the same ISA.

System memory 320 may be configured to store program instructions 322 and/or data 332 accessible by processor 310. In various embodiments, system memory 320 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 320. In other embodiments, program instructions and/or data may be received, sent or stored upon different types of computer-accessible media or on similar media separate from system memory 320 or computer system 300.

In one embodiment, I/O interface 330 may be configured to coordinate I/O traffic between processor 310, system memory 320, and any peripheral devices in the device, including network interface 340 or other peripheral interfaces, such as input/output devices 350. In some embodiments, I/O interface 330 may perform any necessary protocol, timing or other data transformations to convert data signals from one component (e.g., system memory 320) into a format suitable for use by another component (e.g., processor 310). In some embodiments, I/O interface 330 may include support for devices attached through various types of peripheral buses, such as a variant of the Peripheral Component Interconnect (PCI) bus standard or the Universal Serial Bus (USB) standard, for example. In some embodiments, the function of I/O interface 330 may be split into two or more separate components, such as a north bridge and a south bridge, for example. Also, in some embodiments some or all of the functionality of I/O interface 330, such as an interface to system memory 320, may be incorporated directly into processor 310.

Network interface 340 may be configured to allow data to be exchanged between computer system 300 and other devices attached to a network (e.g., network 390), such as one or more external systems or between nodes of computer system 300. In various embodiments, network 390 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 340 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 350 may, in some embodiments, include one or more display terminals, keyboards, keypads, touchpads, scanning devices, voice or optical recognition devices, or any other devices suitable for entering or accessing data by one or more computer systems 300. Multiple input/output devices 350 may be present in computer system 300 or may be distributed on various nodes of computer system 300. In some embodiments, similar input/output devices may be separate from computer system 300 and may interact with one or more nodes of computer system 300 through a wired or wireless connection, such as over network interface 340.

In some embodiments, the illustrated computer system may implement any of the operations and methods described above. In other embodiments, different elements and data may be included.

Those skilled in the art will appreciate that computer system 300 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 300 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 300 may be transmitted to computer system 300 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The embodiments of the present invention may be embodied as methods, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

1. A computer implemented method for anonymous information rights management to allow tracking of downloaded documents without authentication comprising:
receiving, at an IRM server, a request from an anonymous user to access an encrypted document;
in response to receiving the request from the anonymous user, determining an identity of a first user who downloaded the encrypted document from the IRM server, wherein the first user is different from the anonymous user;
determining whether the first user currently has permission to access to the encrypted document; and
providing a decryption key to the anonymous user when the first user is determined to have permission to access the encrypted document.

2. The method of claim 1, further comprising updating a document access history to reflect the access by the anonymous user, including the first user who downloaded the encrypted document.

3. The method of claim 2, wherein the document access history is updated to include identifying information about a device of the anonymous user.

4. The method of claim 1, wherein the first user downloaded the encrypted document from the IRM server and shared the encrypted document with the anonymous user.

5. The method of claim 1, further comprising denying permission to the anonymous user when it is determined that first user no longer has permission to access the encrypted document.

6. The method of claim 5, further comprising updating a document access history to reflect denial of access by the anonymous user.

7. The method of claim 1, wherein providing the decryption key to the anonymous user is performed without requesting or receiving authentication credentials from the anonymous user.

8. A system for identifying locations in photographs using topographic techniques, comprising:
a) at least one processor;
b) at least one input device; and
c) at least one storage device storing processor-executable instructions which, when executed by the at least one processor, perform a method including:
receiving, at an IRM server, a request from an anonymous user to access an encrypted document;
in response to receiving the request from the anonymous user, determining an identity of a first user who downloaded the encrypted document from the IRM server, wherein the first user is different from the anonymous user;
determining whether the first user currently has permission to access to the encrypted document; and
providing a decryption key to the anonymous user when the first user is determined to have permission to access the encrypted document.

9. The system of claim 8, further comprising updating a document access history to reflect the access by the anonymous user, including the first user who downloaded the encrypted document.

10. The system of claim 9, wherein the document access history is updated to include identifying information about a device of the anonymous user.

11. The system of claim 8, wherein the first user downloaded the encrypted document from the IRM server and shared the encrypted document with the anonymous user.

12. The system of claim 8, further comprising denying permission to the anonymous user when it is determined that first user no longer has permission to access the encrypted document.

13. The system of claim 12, further comprising updating a document access history to reflect denial of access by the anonymous user.

14. The system of claim 8, wherein providing the decryption key to the anonymous user is performed without requesting or receiving authentication credentials from the anonymous user.

15. A non-transitory computer readable medium for storing computer instructions that, when executed by at least one processor causes the at least one processor to perform a method for identifying locations in photographs using topographic techniques, comprising:
receiving, at an IRM server, a request from an anonymous user to access an encrypted document;
in response to receiving the request from the anonymous user, determining an identity of a first user who downloaded the encrypted document from the IRM server, wherein the first user is different from the anonymous user;
determining whether the first user currently has permission to access to the encrypted document; and
providing a decryption key to the anonymous user when the first user is determined to have permission to access the encrypted document.

16. The non-transitory computer readable medium of claim 15, further comprising updating a document access history to reflect the access by the anonymous user, including the first user who downloaded the encrypted document and identifying information about a device of the anonymous user.

17. The non-transitory computer readable medium of claim 15, wherein the first user downloaded the encrypted document from the IRM server and shared the encrypted document with the anonymous user.

18. The non-transitory computer readable medium of claim 15, further comprising denying permission to the anonymous user when it is determined that first user no longer has permission to access the encrypted document.

19. The non-transitory computer readable medium of claim 18, further comprising updating a document access history to reflect denial of access by the anonymous user.

20. The non-transitory computer readable medium of claim 15, wherein providing the decryption key to the anonymous user is performed without requesting or receiving authentication credentials from the anonymous user.
